(19) United States
(12) Patent Application Publication
(10) Pub. No.: US 2026/0195246 A1
(43) Pub. Date: Jul. 9, 2026

(54) APPARATUS AND METHOD FOR USE WITH A TEST ASSET

(71) Applicant: JAGUAR LAND ROVER LIMITED, Whitley, Coventry, Warwickshire (GB)

(72) Inventors: Colin HARTY, Whitley, Coventry, Warwickshire (GB); Gonzalo EJARQUE RINALDINI, Whitley, Coventry, Warwickshire (GB); Kevin FAHY, Whitley, Coventry, Warwickshire (GB)

(21) Appl. No.: 19/133,170

(22) PCT Filed: Nov. 23, 2023
(86) PCT No.: PCT/EP2023/082903

§ 371 Date: May 27, 2025

(30) Foreign Application Priority Data
Nov. 29, 2022 (GB) 2217874.3

(51) Int. Cl. G06F 11/3668; G06F 8/10; G06F 8/36

(52) U.S. Cl. CPC G06F 11/3684; G06F 8/10; G06F 8/36; G06F 11/3688

(57) ABSTRACT

A computer implemented method for translating a natural-language test specification to computer executable code for a test asset, comprising: identifying test specification steps within the natural-language test specification, determining, for each test specification step, a step sequence associated with the respective test specification step and an identifier of the test asset, selecting, for each variable within the step sequence, a corresponding variable value associated with the identifier of the test asset, selecting, for functions within the step sequence, a corresponding function associated with the identifier of the test asset, determining asset operations within the step sequence and, for each asset operation, obtaining an operation template of computer program code corresponding to the identifier of the test asset, obtaining a frame template and populating the frame template with the code corresponding to the operation templates to form a block of computer executable code for the test asset.

### CROSS REFERENCE TO RELATED APPLICATIONS

The present application is a U.S. National Phase of International Application No. PCT/EP2023/082903 entitled “APPARATUS AND METHOD FOR USE WITH A TEST ASSET,” and filed on Nov. 23, 2023. International Application No. PCT/EP 2023/082903 claims priority to Great Britain Patent Application No. 2217874.3 filed on Nov. 29, 2022. The entire contents of each of the above-listed applications are hereby incorporated by reference for all purposes.

### TECHNICAL FIELD

The present disclosure relates to methods and apparatus for use with test assets. In particular, although not exclusively, aspects of the present invention relate to translating a natural-language test specification to computer executable code for a test asset. Aspects of the invention relate to a method, to an apparatus, to a system and to a computer readable medium.

### BACKGROUND

In order to increase operational reliability it is known to test components or modules during development of a system or product, such as a vehicle. For example, it is known to test modules of a vehicle, such as mechanical or electromechanical modules e.g. a suspension module, for example, a suspension damper, to determine a reliability of the module in use. Similarly, it is known to test electronic modules such as electronic control units (ECUs) during development of a vehicle. In all cases, the module under test is associated with a test environment e.g. a test apparatus or rig which subjects the module to use, or accelerated use, conditions. A combination of the test apparatus and the module under test may be known as a test asset. The electromechanical module may be subjected to electrical and/or mechanical stimulus. The electronic module may be subjected to electronic stimulus providing one or more inputs e.g. in the form of digital and/or analogue signals and receiving an output from the module. In order to control the test apparatus it is necessary to provide the test apparatus with computer readable instructions or computer executable code defining test operations to be applied to the module. However difficulties have been observed in producing such computer executable code which sufficiently tests the module i.e. to subject the module to a broad range of input conditions.

It is known to provide method and apparatus for providing computer executable code for testing modules, such as for use with a vehicle.

It is an aim of the present invention to address one or more of the disadvantages associated with the prior art.

### SUMMARY OF THE INVENTION

Aspects and embodiments of the invention provide a method, an apparatus, a system and a computer readable medium as claimed in the appended claims.

According to an aspect of the present invention there is provided a computer implemented method for translating a natural-language test specification to computer executable code for a test asset, the method comprising identifying one or more test specification steps within the natural-language test specification, determining, for each test specification step within the test specification, a step sequence associated with the respective test specification step and an identifier of the test asset, selecting, for each of one or more variables within the step sequence, a corresponding variable value associated with the identifier of the test asset, selecting, for one or more functions within the step sequence, a corresponding function associated with the identifier of the test asset, determining one or more asset operations within the step sequence and, for each asset operation, obtaining an operation template of computer program code corresponding to the identifier of the test asset, obtaining a frame template and populating the frame template with the computer program code corresponding to the one or more operation templates to form a block of computer executable code for the test asset. Advantageously testing of the test asset is improved owing to improved translation of the natural-language test specification to the computer executable. The computer executable is able to provide better coverage for test scenarios detailed in the natural-language test specification due to the computer implemented translation. As such, reliability of a module tested as part of the test asset is improved. Faults with the module are better able to be detected as part of the testing process.

The method may comprise providing the computer executable code to the test asset for execution by one or more processors for testing a module. Advantageously the test asset is able to execute the code to perform testing of the module. Advantageously the test asset executes the received code such that testing is automatically performed based upon the natural-language test specification. As a result a time to perform testing of the module is reduced.

The method may comprise compiling the computer program code to form the computer executable code for the test asset. Advantageously the computer program code is compiled to produce the executable suitable for the test asset.

The one or more asset operations optionally comprise defining at least one data type, a corresponding data direction and a source of a value for the data type from the test asset. Advantageously a definition is provided for the data type including a source for the value.

The source of the value for the data type may be an input of the test asset. Advantageously the module is tested using inputs to provide data for the test.

The method may comprise concatenating the block of program code to one or more previously-generated blocks of computer program code. Advantageously the computer program code is generated in a block-wise manner using a plurality of blocks of computer program code. Each individual block of code is generated from the test specification.

The determining the step sequence associated with the respective test specification step optionally comprises obtaining the step sequence from a step sequence catalogue in dependence on the identifier of the test asset. Advantageously step sequences are provided from the catalogue which reduces a complexity of the conversion.

The selecting the corresponding variable value associated with the identifier of the test asset may comprise obtaining the variable value from a variable value catalogue in dependence on the identifier of the test asset. Advantageously the value of a variable is appropriate for the test asset identified by the identifier.

The selecting the corresponding function associated with the identifier of the test asset may comprise obtaining the function name from a functions catalogue in dependence on the identifier of the test asset. Advantageously an appropriate function is objection suitable for the test asset identified by the identifier.

The identifier of the test asset may be indicative of a type of test apparatus. Advantageously different test apparatus may be used and appropriate program code generated for each test apparatus. The identifier of the test asset may be indicative of a module under test. Advantageously different modules may be tested and appropriate program code generated for each module.

The method optionally comprises executing the computer executable code on the test asset. Advantageously the test is performed on the test asset.

According to another aspect of the present invention there is provided an apparatus for translating a natural language test specification to computer code executable on a test asset, the apparatus comprising an interface for receiving the natural-language test specification, at least one processor, a memory storing computer executable instructions, which when executed by the at least one processor, perform a method comprising the steps of determining, for each test specification step within the test specification, a step sequence associated with the respective test specification step and an identifier of the test asset, selecting, for each of one or more variables within the step sequence, a corresponding variable value associated with the identifier of the test asset, selecting, for one or more functions within the step sequence, a corresponding function associated with the identifier of the test asset, determining one or more asset operations within the step sequence and, for each asset operation, obtaining an operation template of computer program code corresponding to the identifier of the test asset, obtaining a frame template and populating the frame template with the computer program code corresponding to the one or more operation templates to form a block of computer executable code for the test asset.

The apparatus is optionally arranged to provide the computer executable code to the test asset for execution by one or more processors for testing a module.

The method may comprise compiling the computer program code to form the computer executable code for the test asset.

The one or more asset operations may comprise defining at least one data type, a corresponding data direction and a source of a value for the data type from the test asset.

The source of the value for the data type may be an input of the test asset.

The computer executable instructions, when executed by the processor, may be arranged to concatenate the block of code to one or more previously-generated blocks of computer executable code.

The determining the step sequence associated with the respective test specification step may comprise obtaining the step sequence from a step sequence catalogue in dependence on the identifier of the test asset.

The selecting the corresponding variable value associated with the identifier of the test asset optionally comprises obtaining the variable value from a variable value catalogue in dependence on the identifier of the test asset.

The selecting the corresponding function associated with the identifier of the test asset may comprise obtaining the function name from a functions catalogue in dependence on the identifier of the test asset.

The identifier of the test asset is indicative of a type of test apparatus.

The identifier of the test asset may be indicative of a module under test.

The apparatus may be arranged to execute the computer executable code on the test asset.

According to yet another aspect of the present invention there is provided a system comprising the apparatus described above and a test asset, wherein the apparatus is arranged to provide the computer executable code to the test asset and the test asset is arranged to execute the code for testing a module.

The module may be an electronic control unit for a vehicle.

According to a still further aspect of the present invention there is provided computer readable instructions which, when executed by a computer, are arranged to perform a method as described above. The computer readable instructions may be stored on a computer readable medium. The computer readable medium may be non-transitory.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle according to an embodiment of the invention;

FIG. 2 shows an illustration of a system according to an embodiment of the invention;

FIG. 3 shows a test asset according to an embodiment of the invention;

FIG. 4 a schematic illustration of a test specification apparatus according to an embodiment of the invention; FIG. 5 illustrates a method according to an embodiment of the invention;

FIG. 6 illustrates an example natural language test specification according to an embodiment of the invention;

FIG. 7 illustrates a step catalogue according to an embodiment of the invention; FIG. 8 illustrates a step sequence according to an embodiment of the invention;

FIG. 9 illustrates a variable value catalogue according to an embodiment of the invention;

FIG. 10 further illustrates the step sequence according to an embodiment of the invention;

FIG. 11 illustrates a function catalogue according to an embodiment of the invention;

FIG. 12 further illustrates a portion of the step sequence according to an embodiment of the invention;

FIG. 13 illustrates templates according to embodiments of the invention;

FIG. 14 illustrates an instantiated frame template according to an embodiment of the invention; and FIG. 15 illustrates computer program code generated according to an embodiment of the invention.

### DETAILED DESCRIPTION

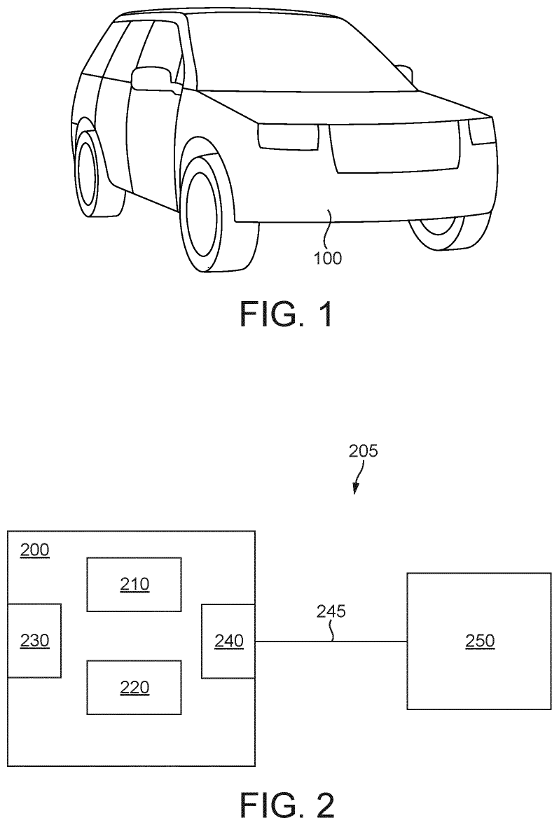

A vehicle 100 in accordance with an embodiment of the present invention is described herein with reference to the accompanying FIG. 1. As shown in FIG. 1, the vehicle 100 in the present embodiment is an automobile, such as a wheeled vehicle, but it will be understood that embodiments of the present invention may be used in other types of vehicle, such as aircraft and watercraft. The vehicle 100 comprises a plurality of mechanical, electromechanical and electronic modules. For example, the vehicle 100 may comprise a plurality of suspension modules e.g. comprising arms, bushes, springs and dampers. In some vehicles the dampers may be electromechanical to receive an electrical signal indicative of one or more desired characteristics of the damper e.g. selected damping rate. Similarly, the vehicle 100 comprises a plurality of electronic modules such as electronic control units (ECUs) e.g. a body control module (BCM) or a drivetrain control module, as non-limiting examples. It is desired to test such modules, for example during development of the vehicle 100 by a manufacturer.

In order to test a module of the vehicle 100, the module is combined with a test apparatus to form a test asset which executes computer readable instructions or computer executable code defining test operations to be applied to the module. The computer executable instructions may define a test stimulus to be applied to the module and, in some embodiments, an expected response of the module to the test stimulus such as a mechanical or electrical response to the test stimulus.

FIG. 2 illustrates an apparatus 200 according to an embodiment of the invention which forms part of a test system 205 together with a test asset 250.

The apparatus 200 as illustrated in FIG. 2 comprises one controller 200, although it will be appreciated that this is merely illustrative and that further controllers 200 may form the apparatus 200. The apparatus 200 or controller 200 comprises processing means 210 and memory means 220. The processing means 210 may be one or more electronic processing device 210 or processor 210 which operably executes computer-readable instructions. The memory means 220 may be one or more memory device 220 or memory 220. The memory 220 is electrically coupled to the processor 210. The memory 220 is configured to store instructions, and the processor 210 is configured to access the memory 220 and execute the computer-executable instructions stored thereon.

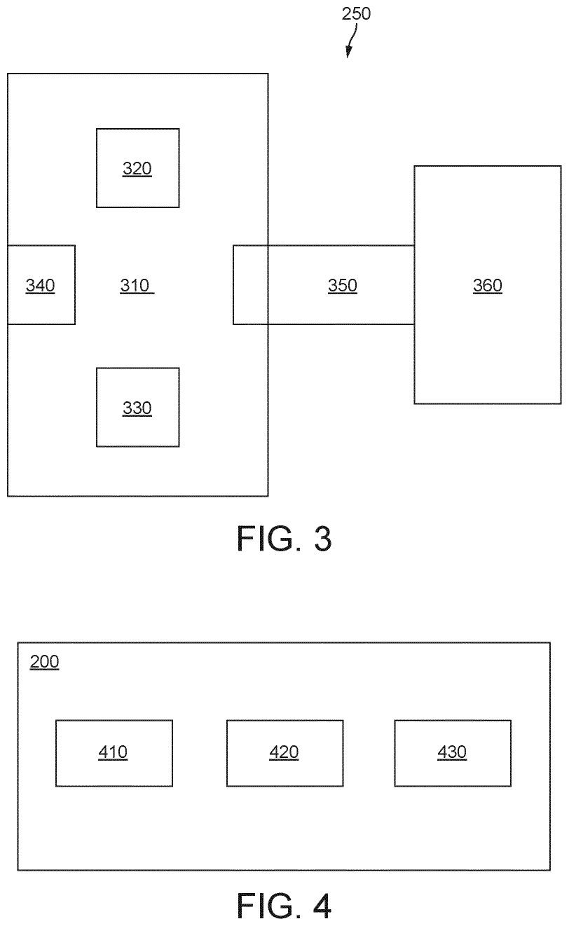

The apparatus 200 comprises an input means 230 and an output means 240. The input means 230 may be a user interface (UI) 230 for receiving a user input to define a test stimulus, as will be discussed. In other embodiments, the input means 230 may be an interface to receive data indicative of the test stimulus from another computer system, such as a network interface to receive said data from a remote computer system via a computer network such as the Internet. The output means 240 is an output for providing computer executable code 245 to a test asset 250 as discussed further below in relation to FIG. 3. The computer executable code is executed to apply the test stimulus to a module under test. The apparatus 200 may be referred to as a test specification apparatus 200, which may be a user computer or a server computer, for receiving the indication of the test specification from either a user as a user input or data indicative of the test specification from another computer.

The user input or data received at the test specification apparatus 200 may correspond to a natural-language test specification. The test specification may define the test stimulus. The test stimulus may be defined by a nature of an input test stimulus e.g. a force or electrical input to be applied to the module under test and, in some embodiments, a timing of the test stimulus e.g. a change in force e.g. type, magnitude, direction or a type e.g. digital or analogue, magnitude, direction etc. The test specification may define one or more conditions which are to exist before application of the test stimulus. For example, the one or more conditions may define a state of the module, such as a state of one or more inputs, and/or an internal state of the module prior to application of the test stimulus. The test specification may define one or more expected outcomes of the test, such as an expected outcome after application of the test stimulus. In dependence on the one or more expected outcomes of the test a success or failure of the test may be determined. For example, comparing an observed outcome of the test, such as one or more outputs or a state of the module after the test, with the observed output it may be determined whether the module performs correctly i.e. the test is successful, or the test fails when the observed output is not substantially equal to the expected output or state of the module. In embodiments of the present invention the natural-language test specification is converted to the computer executable code 245 for automatically applying the test stimulus to the module, as will be explained. The computer executable code 245 is provided to the test asset 250 for executing a test routine which applies the test stimulus to the module under test. In the illustrated example, the test specification apparatus 200 is separate or distinct from the test asset 250. However, it will be realised that in other embodiments the test specification may be received and converted to computer executable code by a single computing apparatus which may subsequently apply the test stimulus to the test module.

FIG. 3 illustrates an example of the test asset 250 in more detail. The test asset 250 comprises a test apparatus 310, or test rig 310, associated with, in use, a module 360 for testing. The test apparatus 310 comprises processing means 320 and memory means 330. The processing means 320 may be one or more electronic processing devices 320 or processors 320 which operably execute computer-readable instructions.

The memory means 330 may be one or more memory devices 330 or memories 330. The memory 330 is electrically coupled to the processor 320. The memory 330 is configured to store instructions, and the processor 320 is configured to access the memory 330 and execute the computer-executable instructions stored thereon. The memory 330 is arranged to store the received computer executable code 245 discussed above. The test apparatus 310 comprises an interface 340 for receiving the computer executable code 245 defining the test stimulus. The interface 340 is an electrical interface such as a network interface 340 for receiving the computer executable code 245 and, in some embodiments, providing test data indicative of a result of the test to the test specification apparatus 210.

The test apparatus 310 further comprises an output means 350 which is arranged to output a test stimulus to be applied, in use, to the module 360 under test. The test stimulus may be one or both of mechanical e.g. compressive, tensile or torsional force, or electrical e.g. one or more electrical signals applied to the module 360. In FIG. 3 the output means 350 is illustrated as partly extending outside of the test apparatus 310 since the output means may comprise one or more actuators 350 for applying a mechanical force to the module 360, such as a compressive or torsional force, for example. In some embodiments, the output means 350 may be an input/output (IO) interface 350 which applies electrical signals to the module 360 and may receive an electrical output therefrom, such that the test apparatus 310 is able to communicate with the module 360, such as an ECU. In use the I/O interface 350 applies one or both of digital and/or analogue signals to the module 360 e.g. ECU 360 and receives electrical signals therefrom, such as digital and/or analogue signals. For example, the I/O interface 350 may comprise a communication bus, such as that present in the vehicle 100, e.g. a CANBus or other network communication bus.

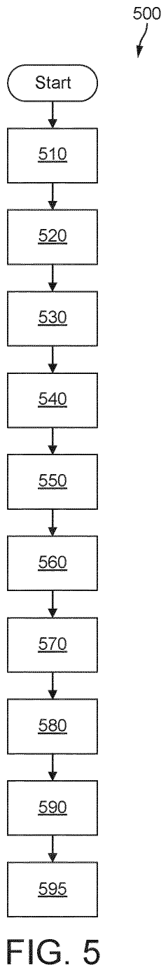

FIG. 4 schematically illustrates an embodiment of the test specification apparatus 200 and functional units thereof which comprise one or more catalogues 410, 420, 430. In an illustrated embodiment, the test specification apparatus 200 comprises a plurality of catalogues, such as three catalogues 410, 420, 430, with it being understood that this is an example and other number of catalogues being envisaged. In one embodiment the catalogues 410, 420, 430 comprise one or more of a step sequence catalogue 410, a variable value catalogue 420 and a functions catalogue 430. Use of said catalogues 410, 420, 430 for converting the natural-language test specification to the computer executable code 245 for automatically applying the test stimulus to the module 360 will be described with reference to FIG. 5.

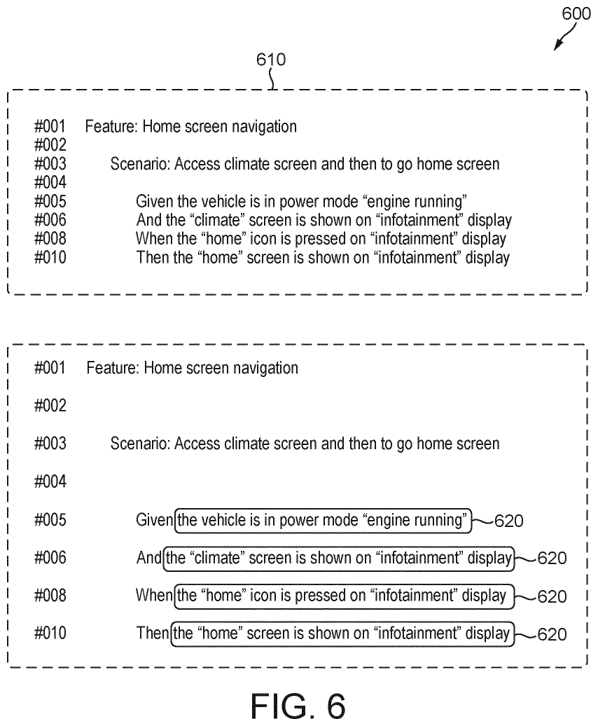

FIG. 5 illustrates a method 500 according to an embodiment of the invention. The method 500 is a method of converting a natural-language test specification to computer executable code 245. In particular, the method 500 is a method of converting the natural-language test specification to the computer executable code 245 and providing the computer executable code 245 to a test asset 250 for automatically applying the test stimulus to the module 360. The method 500 may be performed by the test specification apparatus 200 shown in FIG. 2. In particular, the memory 220 may comprise computer-readable instructions which, when executed by the processor 210, perform the method 500 according to an embodiment of the invention. The method 500 will be described in particular with reference to FIGS. 6-15 which provide examples to aid understanding with it being realised that the content of these examples is not limiting.

The method 500 comprises a block for identifying 510 one or more test specification steps within a natural language test specification 600. Referring to FIG. 6 there is illustrated a portion of a natural language test specification which is generally denoted by reference 600. The illustrated test specification 600 comprises an introductory portion 610 which is used to verbally describe i.e. in natural language (which is English in this example), a purpose of the test specification 600. In other words, to describe what functionality of the module 360 the test specification is intended to test. In this case the module 360 is an electronic control unit (ECU) associated with a user interface (UI) or human-machine interface (HMI) of a vehicle such as the vehicle 100 illustrated in FIG. 1. The natural language test specification 600 may be written in a formal language. The formal language may be a behaviour-driven development (BBD) language. The formal language may have a predetermined structure which allows a human-readable test specification to be written. The predetermined structure may be of, or similar to, a form of Given, When & Then statements. ‘When’ defines when an action step is taken e.g. in response to an event, such as triggered by a system or user. ‘Then’ defines one or more outcome steps e.g. what a system should do, which may be compared with an actual outcome to determine a success of a test. The formal language may be Gherkin which defines syntax structures in plain text. Gherkin is suitable for use with Cucumber which is an open source testing tool, although it will be appreciated that other testing tools are available.

In block 510, the one or more test specification steps are identified within the natural-language test specification 600. The natural-language test specification 600 comprises a plurality of steps and is written to test a particular scenario, such as in this case an access being made by a user to a climate control screen of the HMI followed by an access to a home screen of the HMI, which is identified in this example by a “Scenario” line of the natural-language test specification. Each step 620 is an individual definition of a state or action to be carried out by the test asset 250 to test the module 360. In this case, a first step 620 ‘the vehicle is in power mode “engine running”’ defines a state of the module 360 i.e. subjected to conditions or inputs experienced in use in the given state which, in this example, is when the vehicle 100 is in the power mode “engine running”. Thus when executed by the test apparatus 310 the first step causes the apparatus 310 to apply one or more electrical inputs to the ECU 360 corresponding to the state. Similarly, another step 620 defines an input to the ECU 360 ‘the “home” icon is pressed on “infotainment” display’ and when computer-executable code is executed corresponding to said step the test apparatus 310 is arranged to apply a corresponding input, such as a digital signal indicative of the “home” icon being pressed on a display device within the vehicle 100, to the ECU 360. In the example shown in FIG. 6 four steps 620 in the natural language test specification 600 are identified.

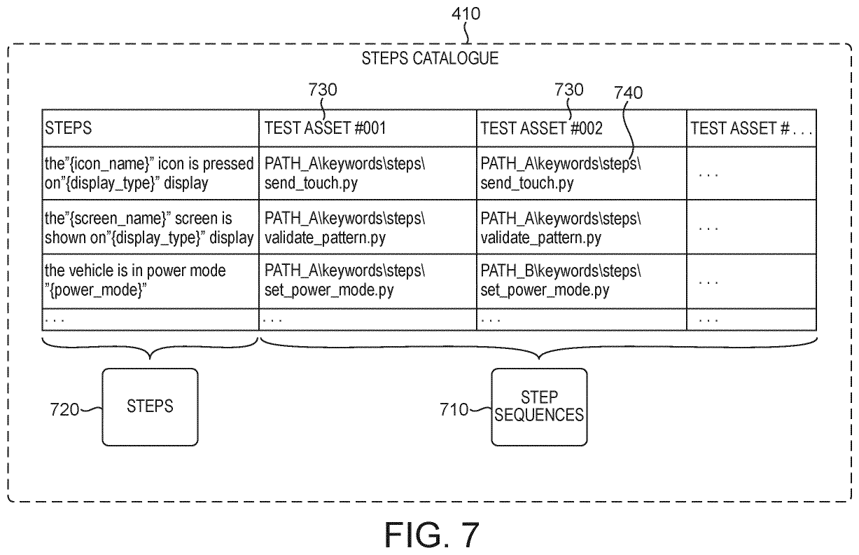

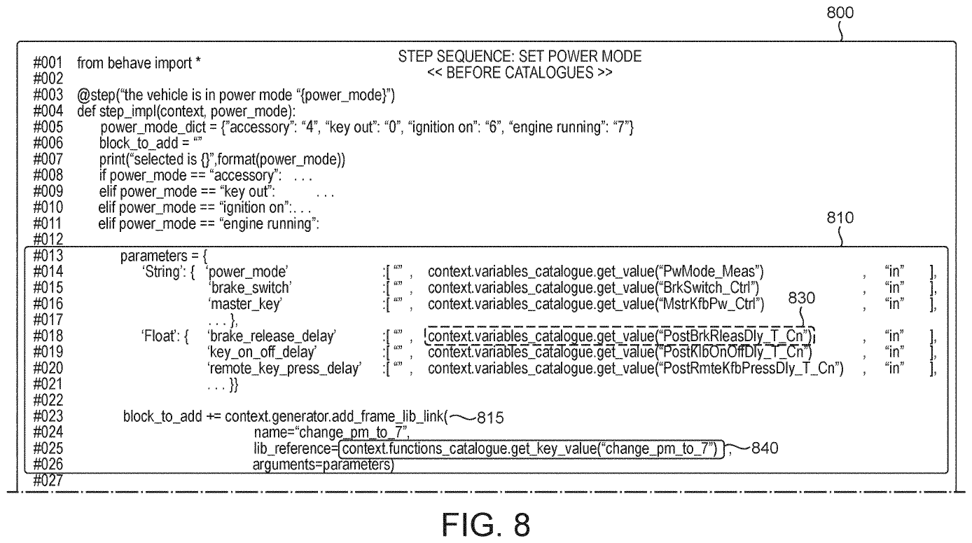

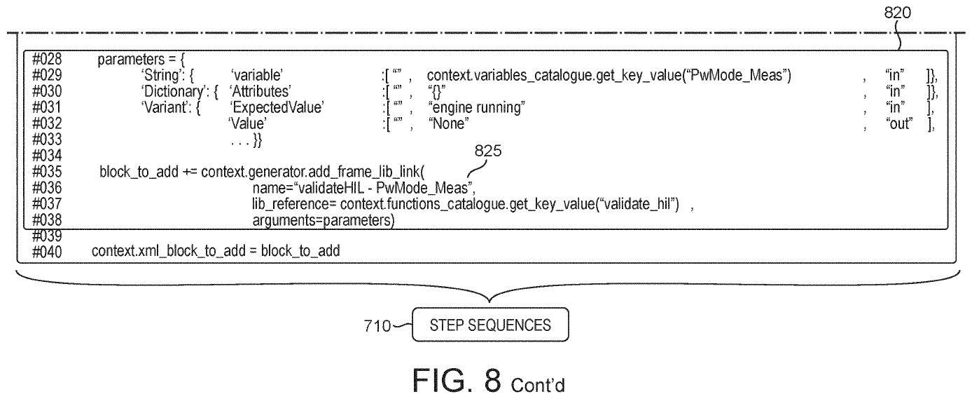

The method 500 comprises a block 520 comprising determining 520, for each test specification step 620 within the natural language test specification 600, a step sequence associated with the respective test specification step 620 and an identifier of the test asset 250. That is, for each of the plurality of steps 620 within the natural language test specification 600 a step sequence is obtained using the step sequence catalogue 410.
a. The step sequence catalogue 410 comprises a plurality of steps and computer program code corresponding thereto. Each catalogue 410, 420, 430 may be a list of elements which are ordered according to predetermined criteria. In some embodiments, a catalogue may be a dictionary wherein elements may be ordered according to an alphabetic criteria, although other criteria may be used. FIG. 7 illustrates an example of the step sequence catalogue 410. The step sequence catalogue 410 comprises a portion 710 of computer program code corresponding to each of the steps 620. In one embodiment the step sequence catalogue 410 is indexed by step 710 and an identifier 730 of the test asset 250. The identifier 730 of the test asset 250 uniquely identifies a combination of the test apparatus 310 and the module 360, in this example the ECU 360. In the example first and second test assets #001, #002 are illustrated. In this way the computer program code obtained from the step sequence catalogue 410 is appropriate for the combination of the test apparatus 310 and the module 360 to be tested. In the example shown in FIG. 7 the step sequence catalogue 410 does not itself contain portions of computer executable code, although embodiments are envisioned in which this is the case. Instead, for each combination of step and test asset 730 an address corresponding to a location of the portion of computer program code is provided, one of which is identified with reference 740.

As can be appreciated, a directory path for some addresses references PATH_A or PATH_B, indicating different portions of computer program code for the combination, whereas for others both TEST ASSET #001 and TEST ASSET #002 have the same address e.g. PATH_A, indicating that the same portion of computer program code is suitable for both combinations of step and test asset. Thus, using the index of step 720 and test asset identifier 730 the corresponding portion of computer program code can be obtained by the test specification apparatus 200.

FIG. 8 illustrates a step sequence 800 corresponding to a ‘set_power_mode’ step sequence in FIG. 7 which is determined in block 520. By step sequence it is meant a plurality or sequence of steps of computer program code to perform the corresponding step in the natural language test specification 600. In the example portion of code, two blocks of computer program code 810, 820 are identified in FIG. 8. As can be appreciated, the step sequence utilises one or more variables in order to perform an operation. Block 530 of the method 500 comprises selecting, for each of one or more variables within the step sequence 800, a corresponding variable value associated with the identifier of the test asset 250. Block 530 is performed utilising the variable value catalogue 420.

Referring to FIG. 8, a first block of program code 810 within the step sequence 800 comprises a first variable 830 indicative of a ‘brake_release_delay’ associated with the vehicle 100. A request to obtain a value for the variable 830 is identified in the block 810 as context.variables_catalogue.get_value(“PostBrkRleasDly_T_Cn”) which references the variable value catalogue 420 and provides a name for the variable PostBrkRleasDly_T_Cn to obtain a corresponding value from the variable value catalogue 420.

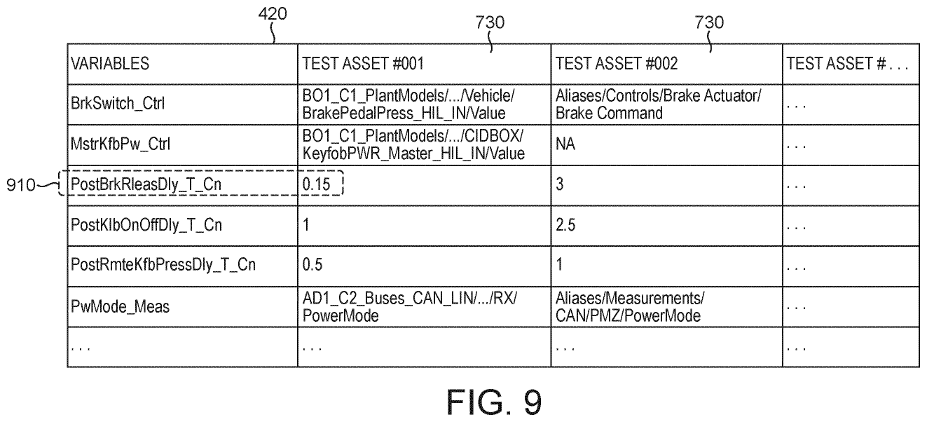

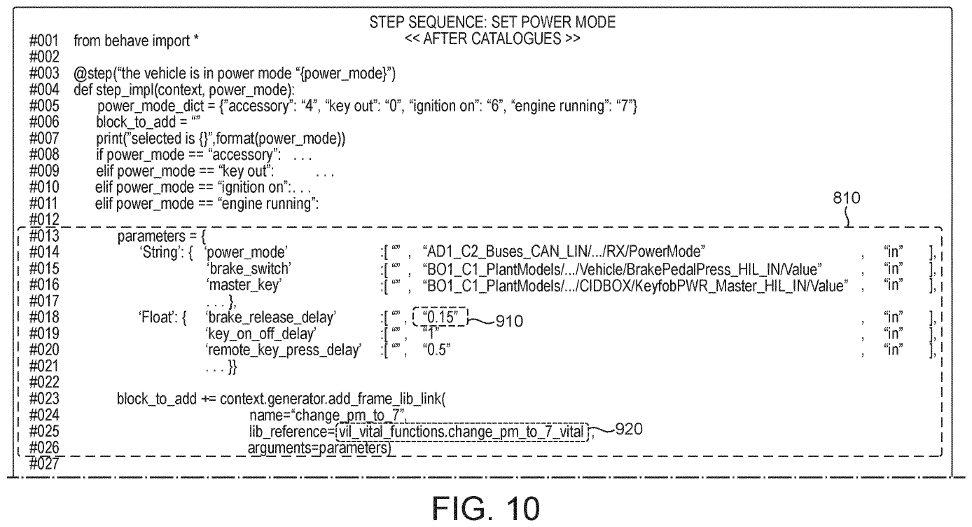

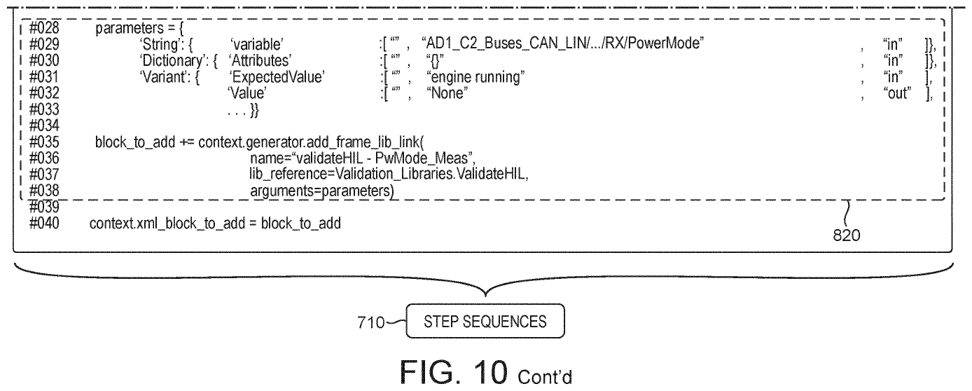

FIG. 9 illustrates a portion of the variable value catalogue 420. The variable value catalogue 420 is indexed by variable name and the illustrated portion comprises a plurality of variables including the variable 910 PostBrkRleasDly_T_Cn. The variable value catalogue 420 is also indexed by the identifier 730 of the test asset 250. The identifier 730 of the test asset 250 uniquely identifies a combination of the test apparatus 310 and the module 360, in this example the ECU 360. As can be appreciated, in the example a value of the variable PostBrkRleasDly_T_Cn is different for the first and second test assets #001, #002. In the example, for the first test asset #001 a value of 0.15 for PostBrkRleasDly_T_Cn is selected in block 530 of the method 500 as indicated with reference numeral 910. The selected variable value is inserted into the first block 810 of program code corresponding to the step sequence 800 corresponding to a ‘set_power_mode’step sequence, as can be appreciated from FIG. 10.

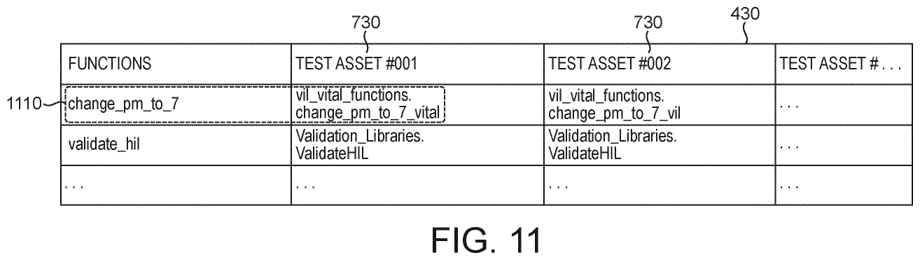

Block 540 of the method comprises selecting, for one or more functions within the step sequence 800, a corresponding function associated with the identifier of the test asset 250. Block 540 is performed utilising the functions catalogue 430. Referring to FIG. 8, a function 840 utilised in the first block 810 of the step sequence 800 is identified. The function is a function “change_pm_to_7” requesting the test asset 250 to change a power mode of the ECU 360 to an identified mode, in this example mode 7, which is referenced as being located within the functions catalogue functions_catalogue_key_value. In block 540 a function is obtained from the functions catalogue 430 a portion of which according to an embodiment of the invention is illustrated in FIG. 11.

The functions catalogue 430 of FIG. 11 is indexed by function name and the illustrated portion comprises a plurality of functions including the function change_pm_to_7. The functions catalogue 430 is also indexed by the identifier 730 of the test asset 250. The identifier 730 of the test asset 250 uniquely identifies a combination of the test apparatus 310 and the module 360, in this example the ECU 360. In the example, for the first test asset #001 a function change_pm_to_7_vital from vil_vital_functions is selected in block 540 of the method 500 as indicated in FIG. 11 with reference numeral 1110. The selected function is inserted 920 into the first block 810 of the step sequence 800, as can be appreciated from FIG. 10.

The method 500 comprises a block 550 of determining one or more asset operations within the step sequence 800 and, for each asset operation, obtaining an operation template of program code corresponding to the identifier of the test asset 250. Referring to FIG. 8, in the first block 810 of the step sequence 800 a plurality of asset operations are instructed. Each asset operations may be associated with an input or output to/from the test asset. For example, an asset operation may READ or GET information from the test asset 250. Similarly, an asset operation may WRITE or SET information from the test asset 250. Each asset operation may include or be associated with one or more of defining at least one data type inputs or outputs, a corresponding data direction and a source of a value for the data type from the test asset 250. The defined data inputs or outputs may be used with the asset operation i.e. a float data type ‘brake_release_delay’ discussed below may be used by an asset operation. The source of the value for the data type is an input of the test asset 250, where the input may be a communications interface such as a communication bus e.g. CANBus or similar. In the example, the asset operation is to change a power mode of the test asset to 7 which makes use of the defined parameters.

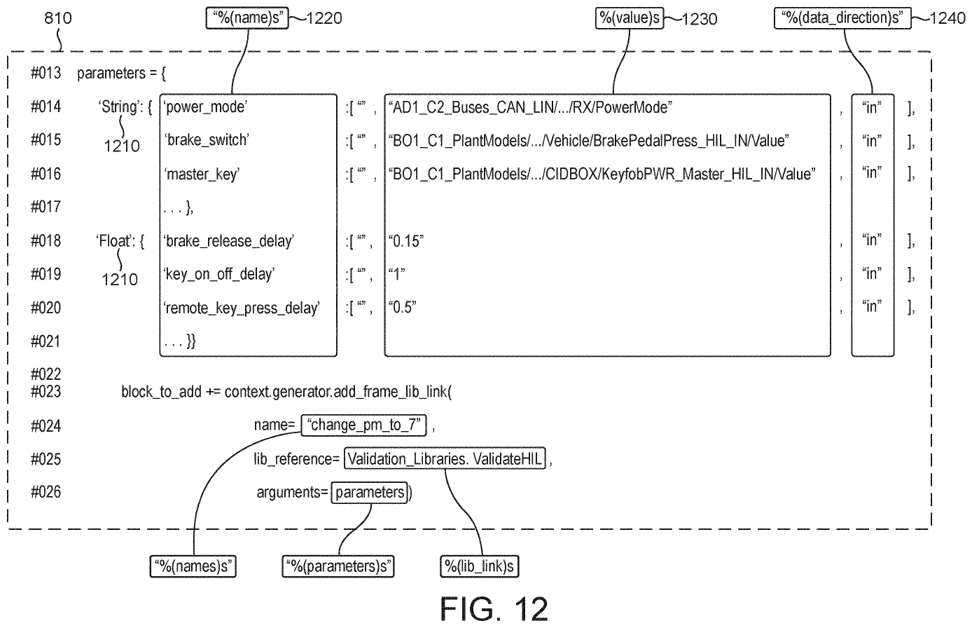

FIG. 12 illustrates the first block 810 of the step sequence 800 and parameters 1210 which, in the example, define a plurality of data types including a plurality of string and float data type as inputs/outputs 1210, although it will be appreciated that these data types are merely examples and that other data types or combinations may be envisaged. In the example string type inputs power_mode, brake_switch and master_key are defined, as examples. In the example, float i.e. floating point numeric data types brake_release_delay, key_on_off_delay and remote_key_press_delay are defined as examples.

For the string data types, a name 1220 of each is defined and a value or source 1230 of a value. In some embodiment a data direction 1240 is defined, which may be one of input or output from the ECU 360. The source 1220 is defined as a location of an input value. For example, the source may be a value of an input to the ECU 360 such as data obtained from the communication bus of the vehicle 100.

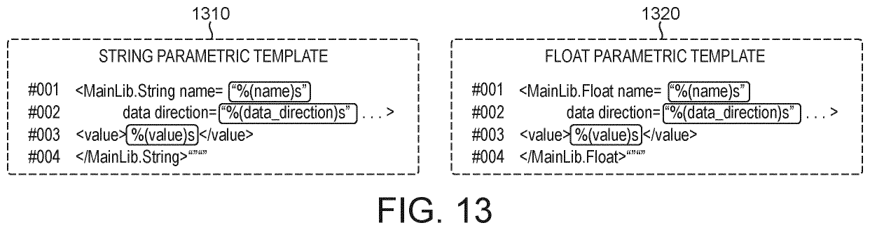

For each definition of a data type e.g. string power_mode, an operation template of computer executable code corresponding to the identifier of the test asset 250 is obtained in block 550. FIG. 13 illustrates templates for string 1310 and float 1320 parameter definitions for the first test asset #001, with each containing portions for the respective name 1220, value 1230 and direction 1240 definitions from the block 810 of code 800 of the step sequence. It will be appreciated from FIG. 12 that three strings and three floats are defined. Thus in block 550 in the example six templates are obtained, three of each of string and float type with it being appreciated that this is merely illustrative. In block 560 the asset operation templates 1310, 1320 are combined using a frame template as will be explained.

Block 560 of the method comprises obtaining 560 a frame template. Block 560 further comprises populating 570 the frame template with the computer executable code corresponding to the one or more operation templates 1310, 1320 to form a block of computer executable code for the test asset 250.

Referring again to the step sequence 800 shown in FIG. 8, each of the first and second blocks 810, 820 comprises an associated frame definition. The frame definition in the example comprises one or more of name, identification of one or more libraries to be used and definition of one or more arguments for the block. Each library provides computer program code which is used to support a realisation of the test specification. For the first block 810, the associated name is “change_pm_to_7”. A library referenced in block 810 is identified in FIG. 8 using a function as resolved in block 540 using the functions catalogue 430 to ‘Libraries.ValidateHIL’.

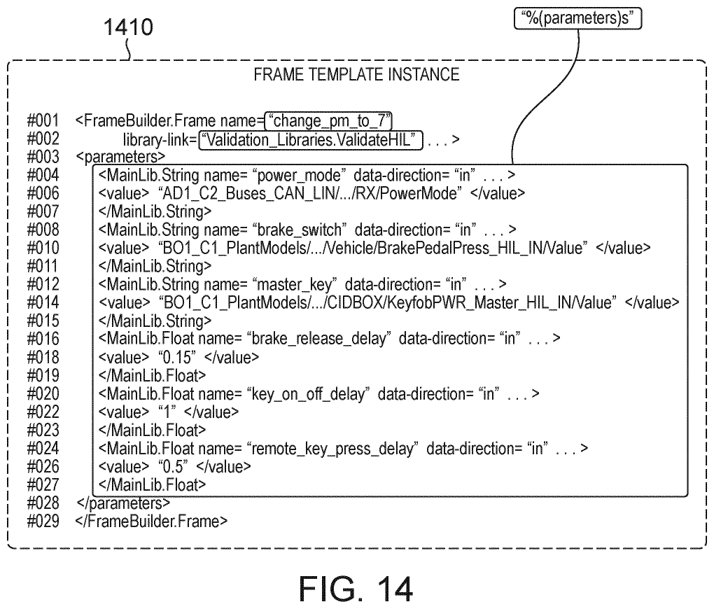

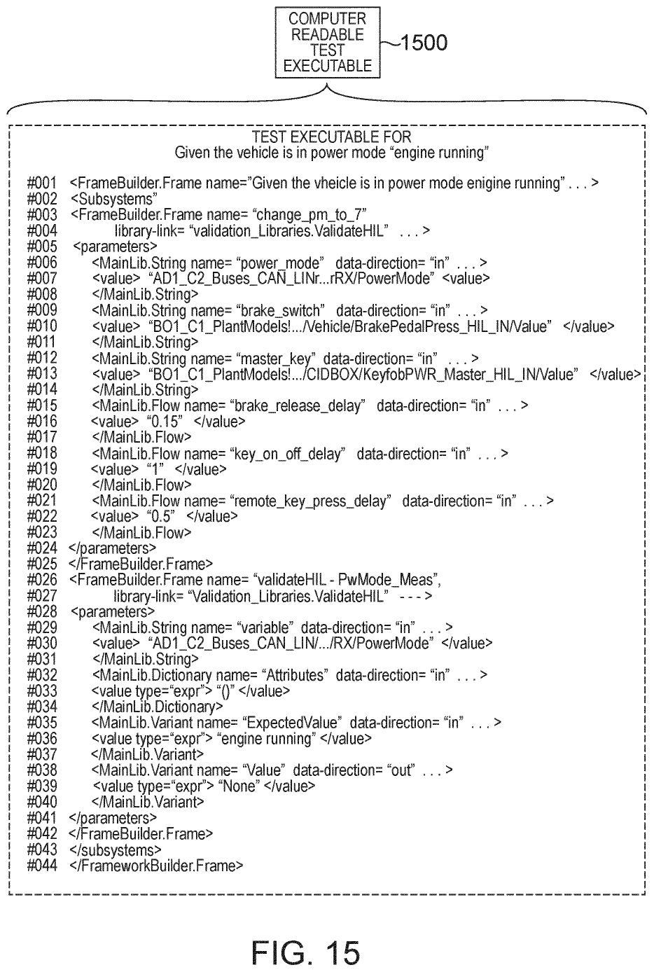

In FIG. 14 a frame template 1410 is illustrated having a definition from the corresponding first block of code 810 e.g. name change_pm_to_7 etc. A body of the frame template 1410 comprises each of the operation templates 1310, 1320 determined in block 550 which in this example defines six data types as explained above. Thus the frame template 1410 provides a frame of computer program code in which to combine the plurality of asset operation templates 1310, 1320. It will be appreciated that a corresponding frame template is also generated for the second block 820 in FIG. 8. Each of the frame templates, populated as described above, thereby forms a corresponding portion or block of program code for the test asset 250.

The method 500 comprises a block 580 of combining or concatenating a block of program code to one or more previously-generated blocks of computer program code. As described above, a frame template 1410 is used to generate or instantiate a first block of code from the first block 810 of the step sequence 800. Similarly a second block of code is instantiated from the second block 820 of the step sequence 800. In one embodiment, the first block of code is concatenated to an end of any previously-generated blocks of computer program code and, similarly, the second block of code is concatenated i.e. appended to an end of the first block, when generated. However it will be realised that in other examples the first and second blocks of code may be combined in other ways, such as be included within a previous block of code such as in a nested manner, or the like. In this way computer program code 1500 is generated for the test asset 250 in block 580.

Once the computer program code 1500 is generated, a program code compilation process is performed to generate an executable for the test asset 250. The compilation process converts the computer program code 1500 into a low-level format for execution by the test asset, as will be appreciated. The program code compilation process is performed by a compiler to produce computer executable for execution by the test asset 250. The executable may comprise instructions e.g. in binary format adapted for an architecture of the test asset as will be appreciated.

In block 590 the executable is communicated to the test asset 250 as computer executable code 245 discussed above with reference to FIG. 2. The computer executable may be communicated from the test specification apparatus 200 to the test asset 250 via a communications network, such as a dedicated communication link or via a computer network which may include a LAN and/or the Internet. Once communicated the computer executable code 245 is stored in the memory 330 of the test asset 250 for execution by the processor 320.

In block 595 the executable stored in the memory 330 is executed by the processor 320 of the test apparatus 310. The test apparatus 310 is arranged to, under control of the code, to test the module 360 such as the ECU 360. It will be appreciated that where the module is of another type appropriate testing may be performed. For example, where the module is an electromechanical damper 360 the test apparatus may apply appropriate electrical inputs to the damper 360 such as to control a stiffness of the damper. Furthermore the test apparatus may apply a mechanical input to the module 360 such as a compressive force to the damper 360 under control of the code 1500 so as to test operation of the damper 360.

Block 595 comprises applying test inputs to the module 360 and, in some embodiments determining an output of the module 360. The output of the module 360 may be one or more electrical outputs of the module 360 in dependence on an operating state of the module 360 and the one or more test inputs. In other embodiments an output of the module 360 may be determined as a response to a mechanical input i.e. position of a portion of the damper or resistance to the input force, for example. Block 595 may comprise recording the one or more outputs of the module 360. In some embodiments, the one or more outputs are compared to expected outputs to determine whether the test is successful.

It will be appreciated that various changes and modifications can be made to the present invention without departing from the scope of the present application.

1. A computer implemented method for translating a natural-language test specification to computer executable code for a test asset, the computer-implemented method comprising:
identifying one or more test specification steps within the natural-language test specification;
determining, for each test specification step within the natural language test specification, a step sequence associated with the respective test specification step and an identifier of the test asset;
selecting, for each of one or more variables within the step sequence, a corresponding variable value associated with the identifier of the test asset;
selecting, for one or more functions within the step sequence, a corresponding function associated with the identifier of the test asset;
determining one or more asset operations within the step sequence and, for each asset operation, obtaining an operation template of computer program code corresponding to the identifier of the test asset; and
obtaining a frame template and populating the frame template with the computer program code corresponding to the one or more operation templates to form a block of computer executable code for the test asset.

2. The computer-implemented method of claim 1, comprising providing the computer executable code to the test asset for execution by one or more processor for testing a module.

3. The computer-implemented method of claim 1, wherein the one or more asset operations comprise defining at least one data type, a corresponding data direction and a source of a value for the data type from the test asset.

4. The computer-implemented method of claim 3, wherein the source of the value for the data type is an input of the test asset

5. The computer-implemented method of claim 1, comprising concatenating the block of computer program code to one or more previously-generated blocks of computer program code.

6. The computer-implemented method of claim 1, wherein the determining the step sequence associated with the respective test specification step comprises obtaining the step sequence from a step sequence catalogue in dependence on the identifier of the test asset.

7. The computer-implemented method of claim 1, wherein the selecting the corresponding variable value associated with the identifier of the test asset comprises obtaining the variable value from a variable value catalogue in dependence on the identifier of the test asset.

8. The computer-implemented method of claim 1, wherein the selecting the corresponding function associated with the identifier of the test asset comprises obtaining a function name from a functions catalogue in dependence on the identifier of the test asset.

9. The computer-implemented method of claim 1, wherein the identifier of the test asset is indicative of a type of test apparatus.

10. The computer-implemented method of claim 1, wherein the identifier of the test asset is indicative of a module under test.

11. The computer-implemented method of claim 1, comprising executing the computer executable code on the test asset.

12. An apparatus for translating a natural-language test specification to computer code executable on a test asset, the apparatus comprising:
an interface for receiving the natural-language test specification;
at least one processor; and
a memory storing computer executable instructions, which when executed by the at least one processor, perform a method comprising:
determining, for each test specification step within the natural-language test specification, a step sequence associated with the respective test specification step and an identifier of the test asset;
selecting, for each of one or more variables within the step sequence, a corresponding variable value associated with the identifier of the test asset;
selecting, for one or more functions within the step sequence, a corresponding function associated with the identifier of the test asset;
determining one or more asset operations within the step sequence and, for each asset operation, obtaining an operation template of computer executable code corresponding to the identifier of the test asset; and
obtaining a frame template and populating the frame template with the computer executable code corresponding to the one or more operation templates to form a block of computer executable code for the test asset.

13. A system comprising the apparatus of claim 12 and a test asset, wherein the apparatus is arranged to provide the computer executable code to the test asset and the test asset is arranged to execute the computer executable code for testing a module.

14. The system of claim 13, wherein the module is an electronic control unit for a vehicle.

15. A non-transitory computer readable medium storing computer readable instructions which, when executed by a computer, cause the computer to perform the computer-implemented method according to claim 1.
